(19) United States
(12) Patent Application Publication
(10) Pub. No.: US 2008/0099399 A1
(43) Pub. Date: May 1, 2008

(54) Filtration system

(75) Inventors: Harry Skinner, Katy, TX (US); Gregory L. Grimme, Katy, TX (US)

Correspondence Address: CONLEY ROSE, P.C.;David A. Rose, P. O. BOX 3267, HOUSTON, TX, 77253-3267, US

(73) Assignee: ITS Engineered Systems, Inc., Katy, TX (US)

(21) Appl. No.: 11/588,756

(22) Filed: Oct. 27, 2006

(51) Int. Cl. B01D 65/02

(52) U.S. Cl. 210/636; 210/321.69; 210/321.83; 210/321.85

(57) ABSTRACT

The invention is an improved filtration module. The filtration system comprises a filter vessel having two or more filtrate outlets mounted at opposite ends of the filter vessel. Alternatively, a seal is placed between the filter vessel and membrane element contained therein to direct the flow of fluid through the membrane element. The presence of two or more filtrate outlets and/or a seal enhances the performance of the filtration system.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### TECHNICAL FIELD

This invention relates to a novel filtration module having improved fluid distribution through one or more filter elements. The improvement is achieved through the use of a seal between the filter membrane element and the filter vessel, the use of two or more filtrate outlets or a combination of these features. A method for improved cleaning of the filter element is also provided.

### BACKGROUND OF THE INVENTION

Membrane based filtration systems are well known in the art. A fluid such as water containing contaminants is introduced into a filter vessel containing a filter membrane. The fluid is forced through the filter membrane. As the fluid passes through the filter membrane, the filter removes the contaminants from the fluid resulting in a clean filtrate. In most industrial applications, the filtration process is continuous, stopping only when the filter becomes saturated with contaminants such that little if any fluid can pass through the membrane. This saturation point usually corresponds with an increase in the trans membrane pressure (TMP).

When the filter membrane becomes clogged or saturated, a backwash cycle is employed to rid the filter of the accumulated contaminants and solids. The backwash is accomplished by forcing clean fluid through the filter in the reverse direction. The backwash may also include the use of chemical cleaning agents to improve the removal of contaminants. The backwash fluid is then drawn out of the vessel. Once backwashing is complete, the filter vessel is ready for normal operations.

In the case of both the filtration or service cycle and the backwash cycle, the flow of fluid into and out of the filter vessel follows a set pattern. Typically, the filter vessels are mounted vertically with the fluid inlet at the bottom of the vessel and the clear fluid or filtrate outlet at the top. In the backwash cycle, these roles are reversed. The cleaning fluid enters from the top and the wash exits through the bottom.

While this design of fluid vessel has proven effective, there exists a need for improved flow through the vessel, especially during the backwash cycle. Also, there exists a need for a vessel design which can accommodate different filter media including hollow tube filters and spiral wound membrane filter.

### BRIEF SUMMARY OF THE INVENTION

The invention is a novel filtration module with improved fluid flow through the filter element. The filtration module comprises a filter vessel having a membrane element contained therein. In one embodiment, a seal is placed between the inner wall of the filter vessel and the membrane element so as to induce a more uniform flow of fluid through the membrane element. In another embodiment, two or more filtrate outlets are provided with at least one filtrate outlet connected to opposite ends of the membrane element. In yet another embodiment, both the seal and plural filtrate outlets are used. The use of the seals and/or a plurality of filtrate outlets allows for a more even flow of fluids through the filter element.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a cross-section of a filter module of the invention.

FIG. 2 is a cross-section of an alternate embodiment of the invention.

FIG. 3 is a cross-section of a third embodiment of the invention.

FIG. 4 is a cross-section of an embodiment using two membrane elements.

### DETAILED DESCRIPTION OF THE INVENTION

The invention relates to an improved filtration module. In the module of the invention, a more even flow of fluid through the filter is achieved thoroughly using a seal between the filter vessel and the membrane element; the use of a plurality of filtrate outlets or both.

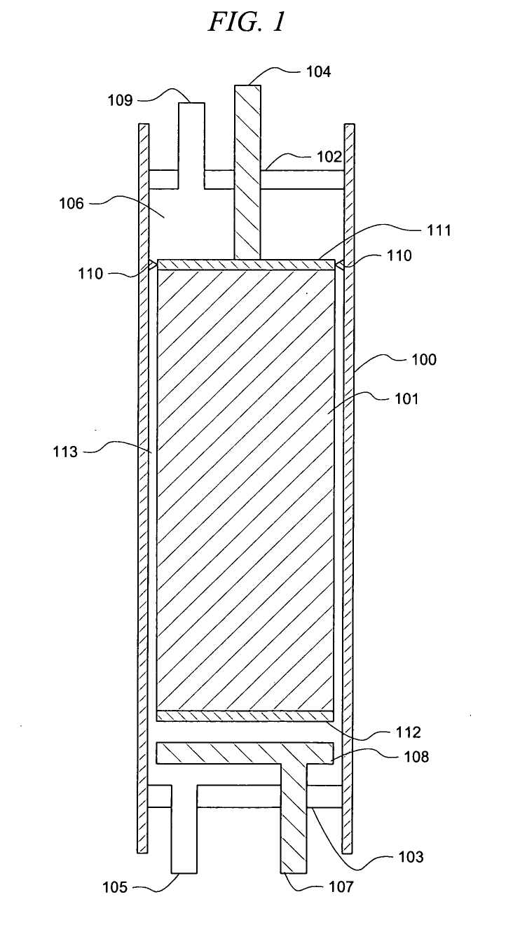

One embodiment of the invention is shown in FIG. 1. The filtration module comprises a filter vessel 100 containing a membrane element 101. The filter vessel is closed at either end by vessel end caps 102 and 103. A filtrate outlet 104 extends through one of the end caps 102 and connects with the membrane element 101 so as to draw filtrate out from the membrane element 101. A fluid inlet 105 extends through the end cap 103 opposite from the filtrate outlet 104. An optional gas inlet 107 extends through the end cap 103 and connects with a gas distributing or diffuser plate 108.

A fluid/gas outlet 109 passes through end cap 102 opposite from the fluid inlet 105 and is in communication with the interior 106 of the filter vessel.

seal 110 is placed between the upper edge 111 of the membrane element 101 and the inner wall 112 of the filter vessel such that the fluid to be filtered contacts the filter membrane 113 of the filter element. The seal is situated such that it prevents fluid from flowing directly from the fluid inlet 105 to the fluid outlet 109 and directs the fluid to pass through the membrane element 101. Without the seal 110, at least a portion of the fluid which enters the filter vessel 100 will pass through the filter vessel 100 without passing through the membrane element 101. The presence of the seal also causes a more even flow of fluid through the membrane, enhancing the effectiveness of the filter.

In one embodiment, the membrane element comprises a spiral wound filter for ultra-filtration of contaminated fluid. In this embodiment, the contaminated fluid enters the membrane element at one end of the membrane element 101 and passes through channels (not shown) within the membrane element. At least a portion of the contaminated fluid exits the membrane module 101 at the opposite end and then exits the filter vessel 100 through the fluid outlet 109. While the membrane element usually fits close against the filter vessel, there is usually a space between the filter vessel 100 and the membrane element 101. This space allows at least a portion of the contaminated fluid to pass around the membrane element 101 and exit the filter vessel 100 without passing through the membrane element 101. By placing a seal 110 between the inner wall of the filter vessel 100 and the membrane element 101, the flow of fluid around the membrane element 101 is prevented and the fluid is directed into the fluid feed channels of the membrane element 101.

The nature of the filter element 101 will depend on the specific use of the filter system. For example, where ultra-filtration of oil field water containing hydrocarbons and a high level of suspended solids is to be accomplished, a backwashable, spiral wound filter comprising polyacrylonitrile membranes is preferred. Other applications will require the use of different types of filters and materials.

The nature of the seal 110 will also vary depending upon the proposed use. In general, the seal should be capable of withstanding the pressures encountered and the nature of the fluid to be filtered. Again, where hydrocarbons are present, the seal should be resistant to degradation by hydrocarbons. In addition, the seal should be serviceable over a wide pH range, typically from about 2.0 to about 11.0.

As discussed above, the filter module may also comprise a gas distribution or diffuser system. This comprises a gas inlet 107 connected to a gas distributor 108 situated at one end of the filter vessel 100. The filter vessels of the invention are typically mounted vertically. In this configuration, the distributor 108 is mounted at the bottom of the vessel, just below the filter element 101. The gas distributor operates by releasing free gas into the fluid containment in the filter vessel 100. The gas is released as fine bubbles which scour the membrane element 101 thereby removing particles which may collect on the membrane surface of membrane element 101. For example, where a spiral wound membrane element is used, the gas will pass through the feed fluid channels in the membrane, removing particles that may accumulate on the membrane surfaces. The gas employed is typically air, however, any gas which does not interfere with the operation of the filter system and does not adversely react with the fluid being filtered may be used.

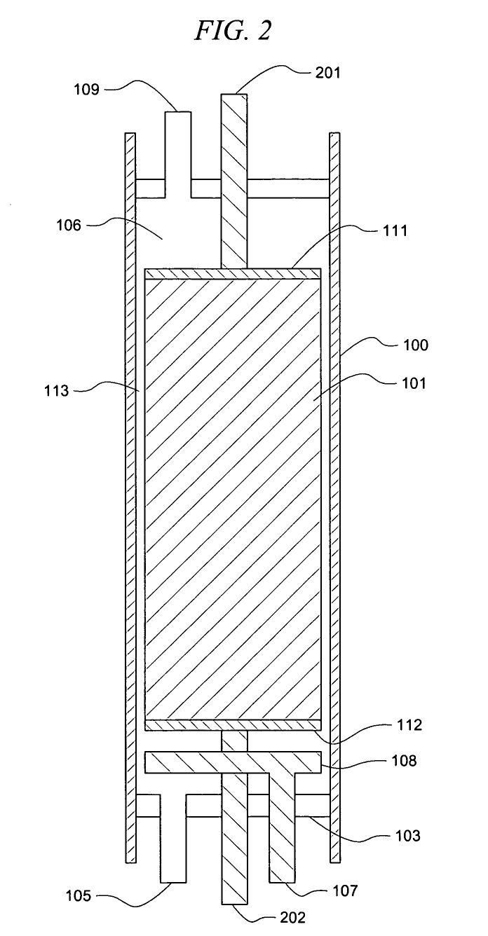

An alternate embodiment is shown in FIG. 2. Again, the system comprises a filter vessel 100 with a membrane element 101. In this embodiment two or more filtrate outlets 201, 202 are provided to draw filtrate out from the membrane element 101. The filtrate outlets 201, 202 are connected to the membrane element 101 so that at least one outlet is attached to either end of the membrane element 101. In this embodiment, a seal is not used between the membrane element and the inner wall of the filter vessel. The use of filtrate outlets 201, 202 at either end of the filter element 101 provides for more uniform flow of fluid through the filter element 101. The remaining elements are as defined in FIG. 1 above.

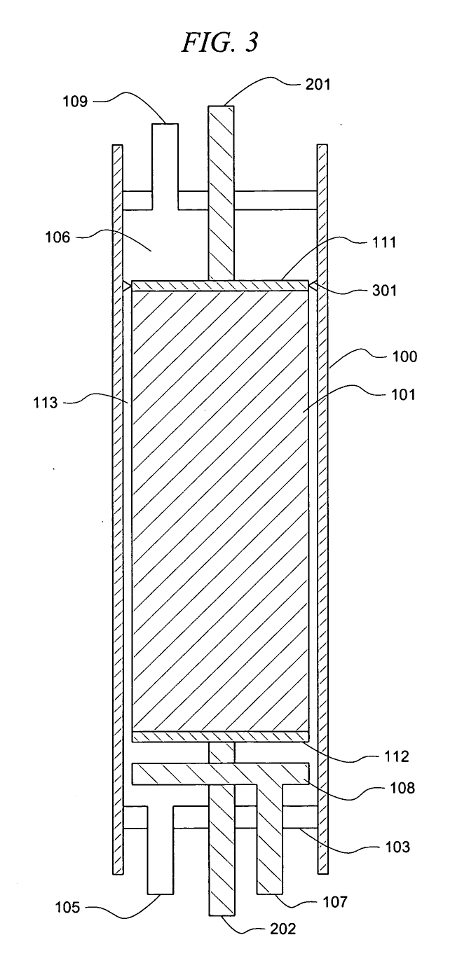

Referring to FIG. 3, a third embodiment is shown. In this embodiment, a seal 301 is used in combination with a plurality of filtrate outlets. As in the embodiment shown in FIG. 1, the seal 301 is located between the inner wall of the filter vessel 100 and the membrane element 101. The permeate outlets 302, 303 are in fluid communication with the membrane element 101. The combination of the seal and the plural filtrate outlets, further enhances the uniform flow of fluid through the filter element. This is true for all phases of filter operation including the service cycle, backwash and clean-in-place.

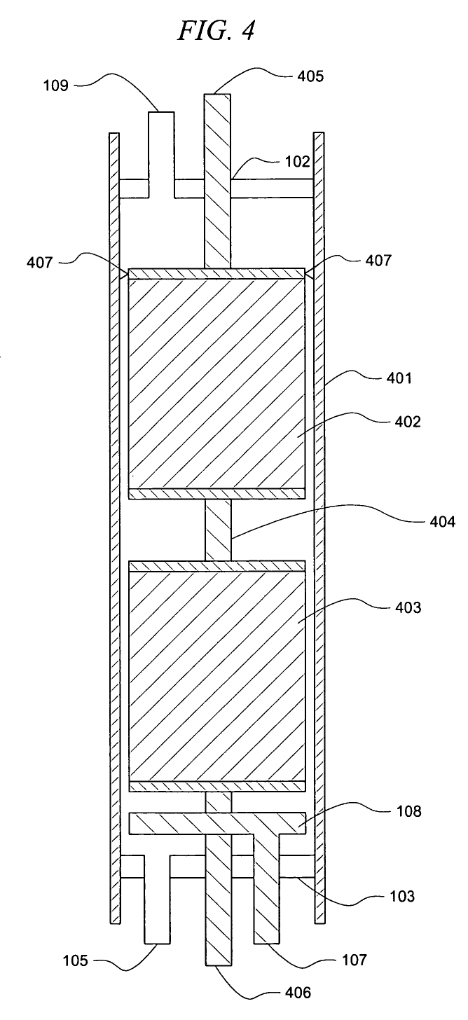

The filter module of the invention can comprise two or more filter modules mounted in series along a single conduit. Referring to FIG. 4, a filter module with two membrane elements is shown. The module comprises a filter vessel 401 having two membrane elements 402, 403 situated within the vessel 401. A central conduit 404 runs through the center of each membrane element and connects to the filtrate outlets 405, 406 at each end of the filter vessel. In this embodiment, a seal 407 is located between the filter vessel and the membrane element 402 located distant from the fluid inlet. While FIG. 4 shows only two membrane elements, it will be obvious to those skilled in the art that additional membrane elements can be mounted with the filter vessel in a manner similar to that described above. Moreover while the seal 407 in FIG. 4 is shown as being placed between the upper membrane element and the filter vessel, the seal may be placed between any or all the membrane elements and the filter vessel.

The filter system of the invention has two basic cycles, the service cycle and the backwash cycle. The service cycle refers to the cycle where contaminants are removed from the contaminated fluid. The backwash cycle refers to the cycle where the contaminants are removed from the filter element.

Referring again to FIG. 1, during the service cycle, a fluid, such as water, containing contaminants is introduced into the filter vessel 100 by means of the fluid inlet 105. Seal 110 restricts the flow of the fluid into the upper portion of the filter vessel directing or inducing the filter fluid to pass through the membrane element. As discussed above, where the membrane element comprises a spiral wound membrane, the contaminated fluid generally enters the membrane element at the lower end of the membrane element, passing through channels within the membrane element. The membrane element removes suspended particles and other contaminants producing a clean filtrate. When the pressure between the feed side of the filter membrane is greater than the pressure on the filtrate side, fluid will flow through the membrane. As the fluid passes through the membrane element 101, contaminants are removed from the fluid resulting in a filtrate on the filtrate side of the membrane not shown in the membrane element 101 by means of a filtrate outlet 104.

In the embodiment shown in FIG. 2, the presence of filtrate outlets 201 and 202 at either end of the filter element ensures that the fluid is drawn evenly through the filter membrane of the filter element 101.

The difference in pressure between the feed side of the membrane and the filtrate side of the membrane is called the trans membrane pressure (TMP). TMP can be created and maintained by several methods. First, a vacuum or vacuums can be associated with the filtrate outlet to draw filtrate out of the vessel. In the case of the embodiments shown in FIGS. 2 and 3, the vacuum can be associated with only one or both filtrate outlets. The withdrawal of filtrate from the filtrate side of the filter decreases the pressure on the filtrate side of the membrane, inducing flow across the membrane.

In another embodiment, the initial fluid is pumped into the filter vessel through the fluid inlet. This causes an increase in the pressure on the feed side of the filter membrane again directing or inducing the fluid to pass through the membrane. In the embodiments shown in FIGS. 1 and 3, the seal directs the flow feed fluid flow into the interior feed channels of the spiral wound filter element. This, in turn, produces a more uniform flow of material across the filter membrane. In yet another embodiment, a pump is used to increase the pressure in the feed side of the filter membrane while simultaneously a vacuum is used to reduce the pressure on the filtrate side of the filter membrane. In still another embodiment, the pressure on the feed side of the membrane is increased, the pressure on the filtrate side of the membrane is decreased and seals are used to direct the flow of fluid into the filter element.

During the service cycle, contaminants accumulate on the membrane surfaces of the membrane element. The introduction of gas bubbles into the fluid during the service cycle can dislodge some of the contaminants allowing for a longer service cycle. The bubbles are introduced by feeding a gas, such as air, into a diffuser 108 by access of the gas inlet 107. The diffuser 108 is positioned such that the gas bubbles it creates scour the feed side of the filtration membrane of the membrane element. As shown in FIG. 1, the diffuser 108 is located below the filter element 101 when the filter vessel 100 is oriented vertically. The introduction of gas bubbles into the feed fluid can be continuous or intermittent.

The duration of the service cycle is dependent on such factors as the nature of the filter membrane and the degree to which the initial fluid is contaminated. Generally, the duration is determined by increased TMP and or flux loss during the service cycle which is caused by the accumulation of solids and other contaminants on the filter membrane surface. When either or both of these conditions occur, a backwash cycle is indicated.

The backwash cycle comprises several steps: a forward flush, a backwash, a service refill, and an air purge.

Again, referring to FIG. 1, during the forward flush step, a flushing fluid such as filtered water, is introduced into the filter vessel 100 by means of the fluid inlet 105. This step removes loose contaminants found on the filter membrane surface and within the feed fluid channels of the filter element. This step may also include introduction of gas bubbles to scour the feed surface of the filter membrane as described above.

Upon completion of the forward flush step, the backwash begins. The backwash is accomplished by introducing a clean fluid such as filtrate, through the filtrate outlet into the membrane element 101. In this case, pressure on the filtrate side of the membrane element 101 is higher than on the feed side, inducing the backwash fluid to pass through the membrane of the membrane element in a reverse direction causing accumulated contaminants to be lifted from the membrane surface and expelled from the membrane element 101. The accumulated contaminants are expelled from the filter vessel through the fluid outlet 109.

As the clean fluid passes through the filter membrane, it removes concentrated contaminants and solids from the membrane. The fluid containing the expelled contaminants is then removed from the vessel 100 by means of the fluid outlet 109 and/or the fluid inlet 105.

In one embodiment, gas bubbles are introduced through diffuser 109 into the fluid to the membrane element to scour the surface of the membrane element 101.

During the backwash cycle, TMP is maintained by controlling the rate at which the clean fluid is introduced into the filter element. This is typically done using a pump with a variable frequency device (VFD). Typical backwash flow rates will be from about 2 to about 2.5 times the service flux.

In the embodiments shown in FIGS. 2 and 3, the clean fluid can be introduced through either of the filtrate outlets 201, 202 or through both. When both outlets are used, they can be used simultaneously or alternatively. The backwash is removed from the vessel by means of the fluid outlet, the fluid inlet or both.

After the backwash has removed the bulk of the concentrated contaminants and solids from the membrane element, a service rinse may be used to remove any remaining contaminants. A service rinse may also be used wherein a chemically enhanced backwash has been used, to remove any residual cleaning chemicals such as caustic from the filter element which were introduced during the backwash step. When a service rinse is employed, a clean fluid, such as filtered water, is introduced into the filter vessel 100 by means of the fluid inlet 105 to wash out any residual fluids. The fluid is removed via the fluid outlet 109.

When the membrane element has been cleaned, a gas purge is used to remove any gas, such as air, from the system. This is accomplished by introducing high quality fluid such as ultra filtered water into the vessel by means of the filtrate outlet 104, 202 or 303. Once the gas has been purged, the filter system is ready for another service cycle.

The cleaning of the filter membranes can be enhanced by the use of various cleaning chemicals during the backwash cycle. This is referred to as a chemical enhanced backwash (CEB). The chemicals typically used in CEB include, but are not limited to, caustic chlorine, acids and the like. The chemicals are introduced into the filter system in the same manner as the backwash described above.

Periodically, when the membrane flux cannot be maintained with backwash cycles and chemically enhanced backwash procedures, membrane modules and filtration membrane media require a more aggressive cleaning procedure to remove contaminants which may have adhered to the membrane surface resulting in reduced flux and/or higher TMP requirement to achieve the designed. The present invention incorporates an integral cleaning tank and associated piping, valves and auxiliary components which provide means for complete clean-in-place (CIP) of the membrane modules, piping and filter membrane(s). Cleaning solutions for the membrane CIP procedures include caustic, acid solutions, chlorine, surfactants, or commercially available cleaning membranes designed for use with separation membranes. The only limitation on cleaning solutions is that they are compatible with all components of the filtration system and approved by the membrane manufacturer. All cleaning procedures including flows, temps. etc. must comply with the membrane manufacturers recommendations and limitations.

Chemical CIP is accomplished by, mixing of cleaning solution in a dedicated cleaning solution make up tank, bringing solution to proper cleaning temperature by means of immersion heater in make up tank and circulating through filter vessel and membrane element. This is generally accomplished by introducing the CIP cleaning solution into the vessel by means of pumps associated with the fluid inlet. The CIP cleaning fluid passes through the filter element(s) and exits through the fluid outlet and returned to a cleaning chemical make up tank (not shown). Any cleaning fluid which passes through the filter membrane is also returned to the make up tank. As with the service cycle, the presence of the seal ensures an even flow of CIP cleaning fluid through the membrane element. In one embodiment, the CIP cleaning fluid is cycled through the filter element(s) in a closed loop system for a period sufficient to remove the contaminants from the filter element. Typically this will be about 30 minutes, however, the actual duration may vary depending upon such factors as the nature of the contaminants, the nature and size of the filter element and the like. Variations of cleaning process can include alternate chemical solutions and/or variations of backwash procedures using filtrate/filtrate quality fluid intermittently with cleaning solutions. Air scour can be used during the cleaning procedure to enhance cleaning effectiveness.

Following the CIP cycle, a forward flush is used to remove any remaining chemicals from the system. This is similar to the flush for the backwash operation discussed above.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A filter module comprising:
a filter vessel;
a first vessel end cap at one end of said filter vessel;
a second vessel end cap at the opposite end of said filter vessel;
at least one filtrate outlet associated with said first end cap;
at least one filtrate outlet associated with said second vessel end cap.

2. The filter module of claim 1 for comprising a membrane element, said membrane element in fluid communication with said filtrate outlets.

3. The filter module of claim 2 wherein said filter element comprises a spiral wound membrane.

4. The filter module of claim 1 further comprising a gas diffusion system located between said membrane element and one of said vessel end caps.

5. The filter module of claim 1 further comprising a seal placed between the inner wall of said filter vessel and said membrane element.

6. A filter module comprising:
a membrane vessel;
a filter element mounted with said filter vessel;
a seal mounted between said membrane element and the inner wall of said filter vessel.

7. The filter module of claim 6 further comprising at least one filtrate outlet in fluid communication with said membrane element.

8. The filter module of claim 6 further comprising a first filtrate outlet in fluid communication with one end of said membrane element and a second filtrate outlet in fluid communication with the opposite end of said membrane element.

9. The filter module of claim 6 further comprising a gas diffusion system mounted with said membrane vessel.

10. The filter module of claim 6 wherein said membrane element comprises a spiral wound membrane.

11. A method for backwashing a filtration module comprising:
simultaneously introducing a backwash into a filtration system by means of two filtrate outlets, each associated with one end of said filtration system.

12. The method of claim 11 further comprising the step of introducing gas bubbles into said filter module.

13. The method of claim 11 further comprises the step of removing contaminants from said filter module.

14. The method of claim 12 wherein said gas is air.

15. The method of claim 11 further comprises the step of introducing cleaning chemicals into said backwash.

16. A method for backwashing a filter module comprising alternately introducing a backwash into a filtration system by means of filtrate outlets attached at opposite ends of a filter vessel.

17. The method of claim 16 further comprising the step of introducing gas bubbles into said filter module.

18. The method of claim 17 wherein said gas is air.

19. The method of claim 16 further comprising introducing a cleaning chemical into said backwash.

20. A method for backwashing a filter module comprising:
flushing the contaminated fluid from the filter module;
introducing a backwash into a filter system by means of two or more filtrate outlets, each associated with opposite ends of said filter module;
removing contaminants from said reactor vessel by means of a fluid outlet; and
rinsing said filter module.

21. The method of claim 20 where in the backwash is introduce into said filtrate outlets simultaneously.

22. The method of claim 20 wherein the backwash is introduced into said filtrate outlets in an alternating pattern.

23. A method for filtering a fluid comprising:
conveying a fluid into a filter vessel;
directing said fluid into a membrane element contained within said filter vessel to create a filtrate; and drawing said filtrate out of said filter element by means of two or more filtrate outlets.

24. The method of claim 23 further comprising the step of directing the flow of said fluid into said membrane element by means of a seal placed between said filter vessel and said membrane element.

25. The method of claim 23 further compressing the step of directing the flow of fluid through said membrane element by increasing the pressure and decreasing the pressure.
